(19) United States
(12) Patent Application Publication
(10) Pub. No.: US 2018/0225326 A1
(43) Pub. Date: Aug. 9, 2018

(54) CHARACTER STRING SEARCH SYSTEM AND CONTROL METHOD THEREFOR

(71) Applicant: Hitachi, Ltd., Tokyo (JP)

(72) Inventors: Michio IIJIMA, Tokyo (JP); Atsushi HATAKEYAMA, Tokyo (JP)

(21) Appl. No.: 15/505,946

(22) PCT Filed: Dec. 1, 2014
(86) PCT No.: PCT/JP2014/081792

§ 371 Date: Feb. 23, 2017

(51) Int. Cl. G06F 17/30

(52) U.S. Cl. CPC G06F 17/30392; G06F 17/30985; G06F 17/30398

(57) ABSTRACT

A character string search system is provided with: a storage device in which, in a first search, an attribute of a searcher who has input a search term for the first search, and a term group composed of one or more search terms used in the first search are associated with one another as rules and are stored; a processor; and a display device. The processor specifies a first rule including a search term input by a searcher in a second search, from among the rules stored in the storage device, and specifies a second rule, including a searcher having an attribute close to the attribute of the searcher in the second search, from among the first rules.

### TECHNICAL FIELD

The present invention relates to a character string search system and a control method therefor.

### BACKGROUND ART

Organizations such as companies are configured with a plurality of departments each of which is a business unit, and each department often has information relates to business. In such organizations, there are cases in which it is necessary to analyze information across a plurality of departments. In this case, since different expressions are used for information having the same meaning between departments, it is difficult to search and extract information having a specific meaning for analysis without omission.

In regard to a character string search of different expressions, for example, Patent Document 1 states “a database is constructed by keywords selected from limited vocabularies using a limited vocabulary dictionary (thesaurus). Then, at the time of search, a search expert selects keywords including extension of synonyms with respect to requested information from the thesaurus.”

### CITATION LIST

### Patent Document

Patent Document 1: JP 62-011932 A

### SUMMARY OF THE INVENTION

### Technical Problem

As stated in Patent Document 1, when the expert searches for information using the thesaurus, it is possible to search even if different expressions are used for information having the same meaning. However, for this purpose, the experts who are familiar with the thesaurus are necessary, but there are few experts or few people having a skill close to an expert. Further, a great deal of time and effort are required to keep the thesaurus up to date.

In this regard, it is an object of the present invention to provide useful terms among search terms used in the past in relation a designated search term so that the provided useful terms are easily used.

### Solutions to Problem

A representative character string search system according to the present invention includes a storage device that associates and stores an attribute of a searcher who inputs a search term for a first search and a term group including one or more search terms used for the first search as a rule, a processor, and a display device, wherein the processor specifies a first rule including the search term input by the searcher in a second search from among rules stored in the storage device, and specifies a second rule including a searcher having an attribute close to the attribute of the searcher in the second search from the first rule.

### Advantageous Effects of the Invention

According to the present invention, is possible to provide useful terms among search terms used in the past in relation a designated search term so that the provided useful terms are easily used.

### BRIEF DESCRIPTION OF THE DRAWINGS

FIG. 1 is a diagram illustrating an example of a search term.

FIG. 2 is a diagram illustrating an example of a configuration of a search system.

FIG. 3 is a diagram illustrating an example of user information.

FIG. 4 is a diagram illustrating an example of rule information.

FIG. 5 is a diagram illustrating an example of character string appearance information.

FIG. 6 is a diagram illustrating an example of a flowchart for a search process.

FIG. 7 is a diagram illustrating an example of a flowchart for creating a rule list.

FIG. 8 is a diagram illustrating an example of a flowchart for correcting a search term.

FIG. 9 is a diagram illustrating an example of a display screen for search.

### DESCRIPTION OF EMBODIMENTS

Hereinafter, exemplary embodiments will be described with reference to the appended drawings. In the following description, information will be described using an expression “table,” but such information need not be necessarily expressed using a table and may be expressed using a data structure other than a table. A process described using a processor as a subject may be a process performed by a computer or an information processing device. All or a part of a process performed by a processor executing a program may be implemented by dedicated hardware. Further, various kinds of programs may be installed in a system or a computer through a program distribution server or a computer readable storage medium.

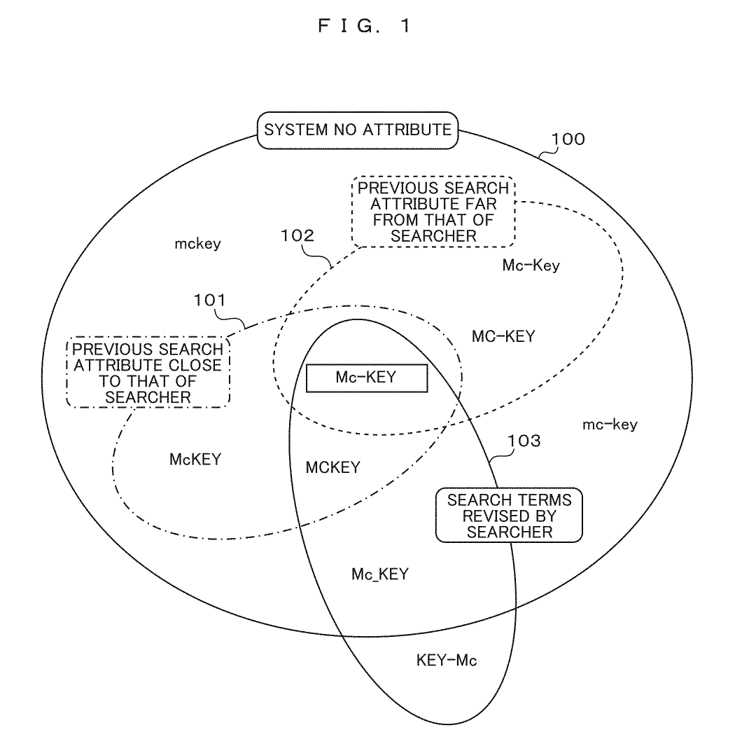

FIG. 1 is a diagram illustrating an example of a search term used by a searcher. Here, a search term is a sequence of one or more characters which is found in a text of a search target in a character string search (a full text search). A term group is a plurality of search terms used for the searcher to find a desired piece of information in a text of a search target. For example, search terms that are different in lowercase characters and uppercase characters in English can be one term group. Further, a character string is a sequence of character expressions or a sequence of character codes, and indicates content of a search term and content included in a text of a search target.

As a preparatory process before a search, a search system (hereinafter also referred to as a “system”) acquires all character strings included in a text of a search target. Then, the system selects character strings by development of lowercase characters and uppercase characters of “Mc-KEY” and development of the presence or absence of a hyphen from all character strings of a text of a search target, for example, centering on “Mc-KEY,” and creates a term group 100. Here, when the system acquires all the character strings of the text of the search target, the system may acquire a position of each character string in the text.

The searcher first performs a search based on the term group 100. In an example of FIG. 1, a term group 101 and a term group 102 have been used in a previous search. Then, when the searcher searches for “Mc-KEY” as a search term, an attribute of a new searcher is compared with an attribute of a searcher who has searched for “Mc-KEY” in the past. The attribute of the searcher will be further described later. For the attributes of the two searchers, there are a close state including an identical state and a far state including a non-identical state, and the term group 101 including “Mc-KEY” which has been previously searched by a search having an attribute close to an attribute of a new searcher is selected.

This is because the close state of the attribute of the searcher is set so that target information is easily acquired using the same search term as the searcher. In the example of FIG. 1, “McKEY” and “MCKEY” are selected in addition to “Mc-KEY.” Based on this selection, the system preferentially displays the term group 101 in the term group 100 so that the term group 101 is likely to be used by the new searcher and, causes it to enter a default use state. An example in which search terms of the term group 100 are displayed, and the search terms of the term group 101 are preferentially displayed will be described later. However, when the term group 101 is likely to be selected, only the search terms of the term group 101 may be displayed.

Thus, the new searcher can search for the search terms of term group 101. Further, the new searcher can perform revision, that is, addition or deletion based on the term group 101 so that appropriate search terms are obtained. This is because the purpose of the search is not always perfectly matched, and a character string serving as a search target changes over time, or a text of a search target is newly added. For example, the new searcher can add a term that is not included in the term group 101 but included in the term group 100, for example, “Mc_KEY,” and can add a term that is not included in the term group 100, for example, “KEY-Mc.”

Further, when the new searcher determines “McKEY” not to be appropriate as the search term, it is possible to exclude “McKEY” included in the term group 101 from the search target. The new searcher can perform a search using the term group 103 created as described above. A term group 103 can easily include “MCKEY” when the term group 101 rather than the term group 102 is used. Then, the term group 103 can be used for a search to be performed later.

As described above, the search term can be easily selected using the previous term group. Particularly, since the previous term group is selected based on the attribute of the searcher, it is possible to suppress selection of a useless search term. Further, it is possible to revise a term group to be suitable for a search, and the revised term group can be further used.

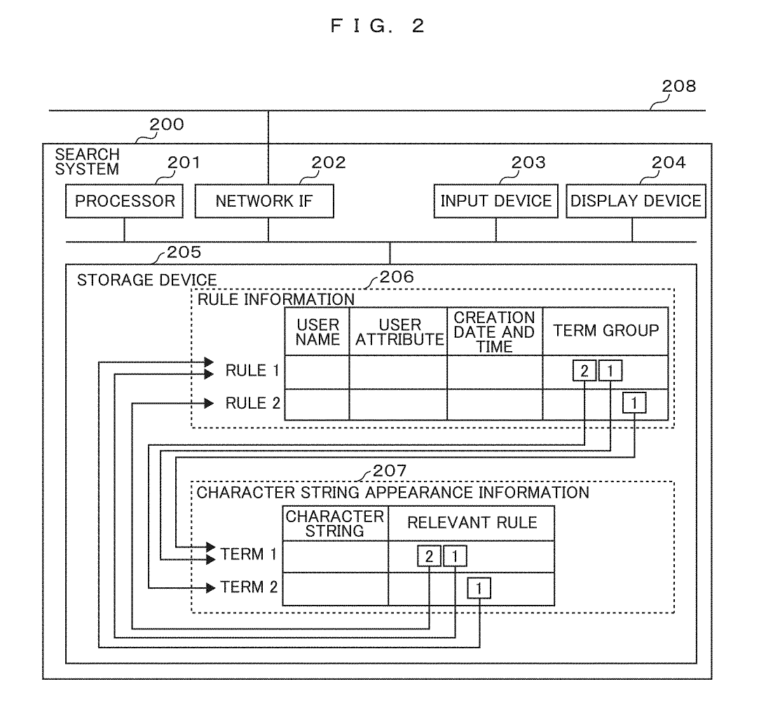

FIG. 2 is a diagram illustrating an example of a configuration of a search system. For example, a search system 200 may be a general computer or may be configured with a plurality of computers. A processor 201 executes a program (not illustrated) stored in a storage device 205 and performs a process related to a search. A network IF 202 is an interface with the network 208, and transmits/receives, for example, part or all of information stored in the storage device 205 to/from other devices via the network 208. Data of a text of a search target may be acquired through communication via the network IF 202, or a part or all of the data of the text of the search target may be stored in the storage device 205.

An input device 203 is a device that receives an input from the searcher (user) such as a keyboard or a mouse. An output device 204 is a device that performs an output to the searcher (user) such as a display device. Input content and output content will be further described later. Instead of the input device 203 and the output device 204, a computer connected to the network 208 may receive an input from the searcher, receive an input through the network IF 202, and transmit an output through the network IF 202, and perform an output to the searcher.

The storage device 205 stores programs and data. The storage device 205 may be a Random Access Memory (RAM) or may include a Hard Disk Drive (HDD), a Solid State Drive (SSD), or the like in addition to a RAM. A RAM and a HDD are separate objects as a device but described as the storage device 205 collectively. The storage device 205 stores rule information 206 and character string appearance information 207 as information to be used for a search. Other information necessary for a search may be stored.

The rule information 206 is information of a term group including one or more search terms, and in the example of FIG. 2, the rule information 206 includes one or more pointers or numbers for one term of the character string appearance information 207 for one search term. A term group of a rule 1 includes a term 1 and a term 2, and a term group of a rule 2 includes the term 1. Since the search term is a character string included in the text of the search target, it is possible to reduce a data amount of the rule information 206 using the character string of the character string appearance information 207 for the term group.

The rule information 206 includes a user name, a user attribute, and a creation date and time. Since a term groups including the same search terms may be created by different users or a term groups including the same search terms may be created by the same user at different dates and times for different purposes, the information is identifiably included. For this reason, one line of the rule information 206 illustrated in FIG. 2 is set as one rule. A term group including the same search terms may have a different rule.

The character string appearance information 207 is information of a character string included in the text of the search target. Since information of a character string is also used as information of a search term as described above, the character string appearance information 207 includes a relevant rule indicating a rule corresponding to a term group in which a character string is included as a search term. In the example of FIG. 2, the character string appearance information 207 includes one or more pointers or numbers for one rule of the rule information 206 for one character string. A relevant rule of the term 1 includes the rule 1 and the rule 2, and a relevant rule of the term 2 includes a rule 2. The information is reverse to the rules of the rule information 206.

The relevant rule of the character string appearance information 207 is information about a rule rather than direct information about a term group because it has a structure depending on the structure of the rule information 206. When the term group including the same search terms has a plurality of rules, the relevant rule substantially designates the term group by having pointers to all of a plurality of rules. One line of character string appearance information 207 illustrated in FIG. 2 is set as one term. This is because the character string is not only the character string included in the text of the search target but also the search term.

Either or both of the rule information 206 and the character string appearance information 207 may be stored in a device connected to the network 208 instead of the storage device 205 of the search system 200 and accessed via the network IF 202. The processor 201 selects the search term with reference to the rule information 206 and the character string appearance information 207, and specifies a position of a character string which is identical to the search term in the text of the search target. Then, the processor 201 stores information related to a new term group in the rule information 206 and the character string appearance information 207. The rule information 206 and the character string appearance information 207 will be described later.

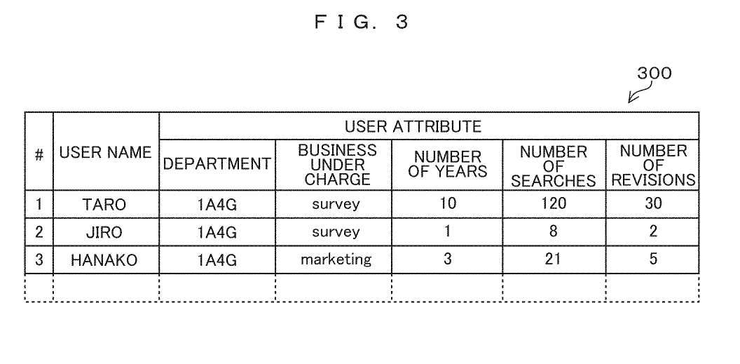

FIG. 3 is a diagram illustrating an example of user information. User information 300 is not limited to information for search, and information for general user management in computers may be used. Therefore, it is expressed as user information rather than searcher information. The user information 300 includes a user attribute related to a search tendency of the user who is a searcher. For example, in the case of a department or business under charge, information related to the same item is likely to be searched using the same product name. In this example, a department is used as the user attribute, but when there is another attribute that tends to have the same character string as a search term, it is not limited to a department, and other attributes may be used. The user attribute of the user information 300 may include the number of years, the number of searches, and the number of revisions of search terms belonging to a corresponding department. The use of such information will be described later.

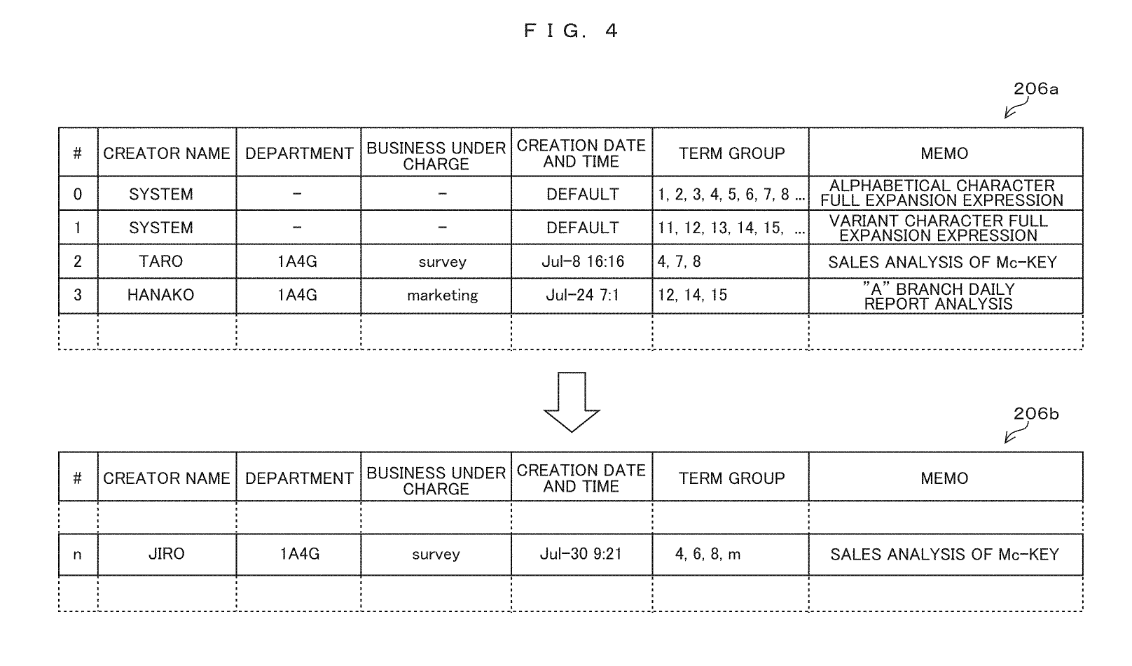

FIG. 4 is a diagram illustrating an example of the rule information 206. Rule information 206a indicates a state before a new search, and rule information 206b indicates a state revised for a new search. The rule information 206a and 206b include information such as a memo in addition to the information described with reference to FIG. 2. A memo is information describing content of a rule so that the rule can be understood by persons later. Further, “#” of the rule information 206a and 206b indicates a number of a rule, “n” indicates an integer of 4 or more, and a dotted line row of the rule information 206b is the same as the information of the rule information 206a.

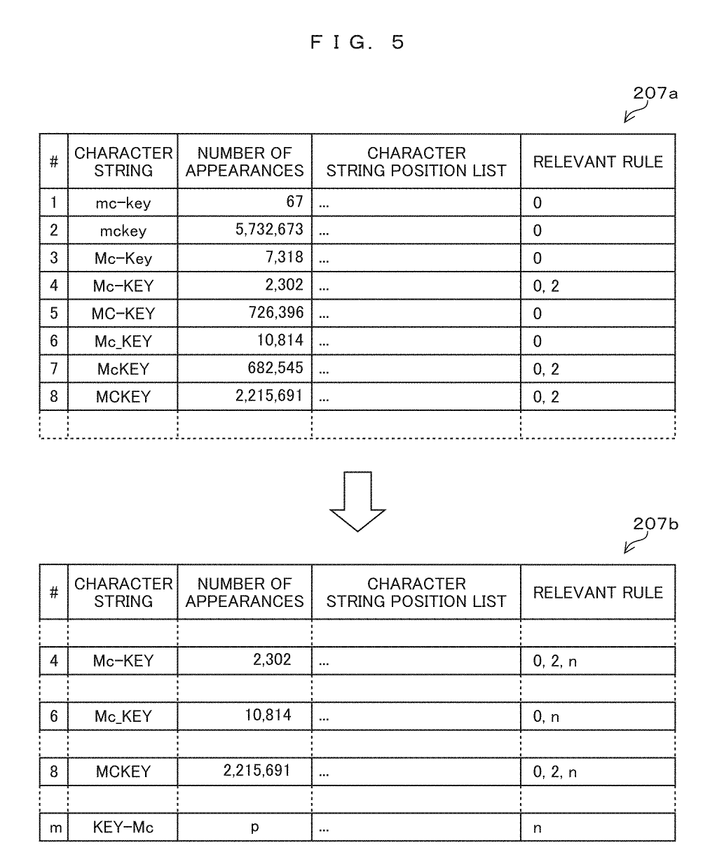

FIG. 5 is a diagram illustrating an example of the character string appearance information 207. Character string appearance information 207a indicates a state before a new search, and character string appearance information 207b indicates a state revised for a new search. The character string appearance information 207a and 207b includes the number of appearances and a character string position list in addition to the information described with reference to FIG. 2. The number of appearances indicates the number of times that a character string appears in the text of search target. The number of appearances is information which is used as a reference when the searcher revises a search term included in a term group or which is used as a reference to a rough standard of a search execution time before a search starts to be executed.

The character string position list indicates a list of positions at which a character string appears in the text of search target. For example, in the case of “mc-key,” since the number of appearances is 67, the character string position list may include 67 pieces of position information. Here, the position information may be the number of characters starting from a first character of the text of the search target. Further, when the number of appearances is large, a data amount of the character string position list increases, and instead of the number of characters from the first character of the text of the search target, for example, information indicating whether or not there is a character string among 100 characters obtained by dividing a text in units of 100 characters may be used.

When there is such information, it is possible to specify a position of a character by pattern matching from the beginning in 100 characters in which there is a character string. Since a method of deciding a search term does not depend on content of the information of the character string position list, and thus further description will be omitted. Further, “#” of the character string appearance information 207a and 207b indicates a number of a term, “m” indicates an integer of 9 or more, a dotted line row of the character string appearance information 207b is the same as the information of the character string appearance information 207a.

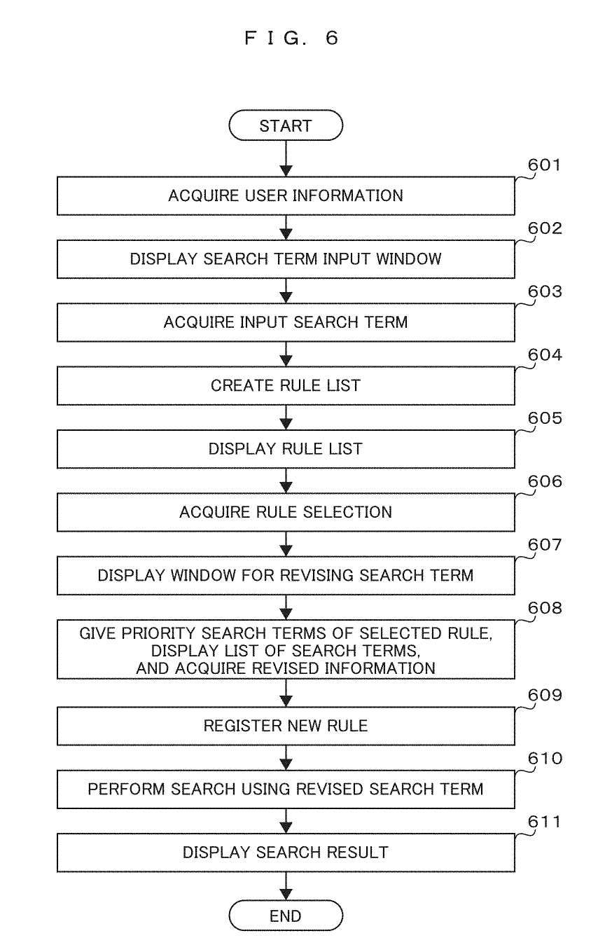

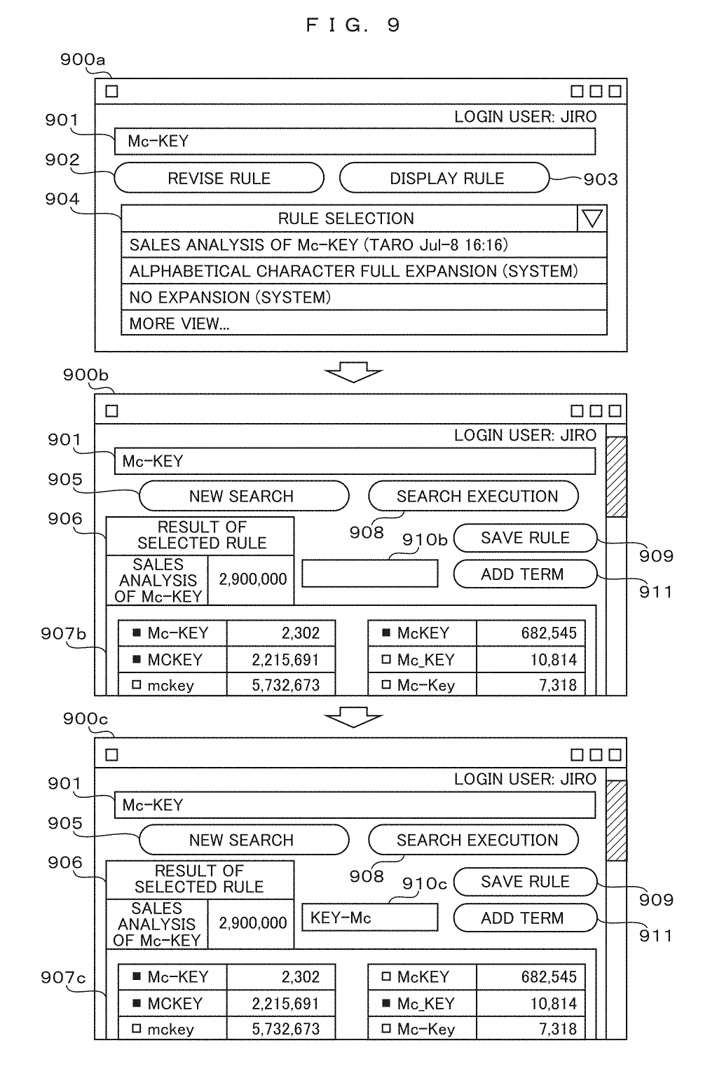

A process of performing reading and writing of the information illustrated in FIGS. 4 and 5, displaying a screen illustrated in FIG. 9, and deciding the search term according to flowcharts illustrated in FIGS. 6 to 8 will be described below. FIG. 9 is a diagram illustrating an example of a display screen for a search. First, FIG. 6 is a diagram illustrating an example of a flowchart of an overall search process. Steps of this flowchart are performed by the processor 201. In step 601, the processor 201 acquires information of the user which is the searcher. The processor 201 may perform step 601 when the user logs in the search system 200. The information of the user is the user information 300 described above with reference to FIG. 3.

In step 602, the processor 201 causes a window for inputting a search term to be displayed on the display device 204. The window is a window 900a illustrated in FIG. 9. At this point in time, a menu 904 may not be displayed. In the windows 900a, 900b, and 900c, for example, names of the users who have logged in are displayed on the upper right of the user information 300 are displayed based on the user information 300 acquired in step 601. An input field 901 of the window 900a is a field in which the user who is the searcher inputs the search term. When the user inputs characters by operating the keyboard of the input device 203, the characters inputted to the input field 901 are displayed.

When the user inputs the search term to the input field 901 and clicks a button 903 by operating the mouse of the input device 203, in step 603, the processor 201 acquires the search term input to the input field 901. The search term may be similarly acquired by detecting an input to the input field 901 even when the button 903 is not pressed down. In the example of FIG. 9, a character string “Mc-KEY” is acquired. The button 903 is a button for displaying a rule based on the inputted search term, and in step 604, the processor 201 creates a rule list.

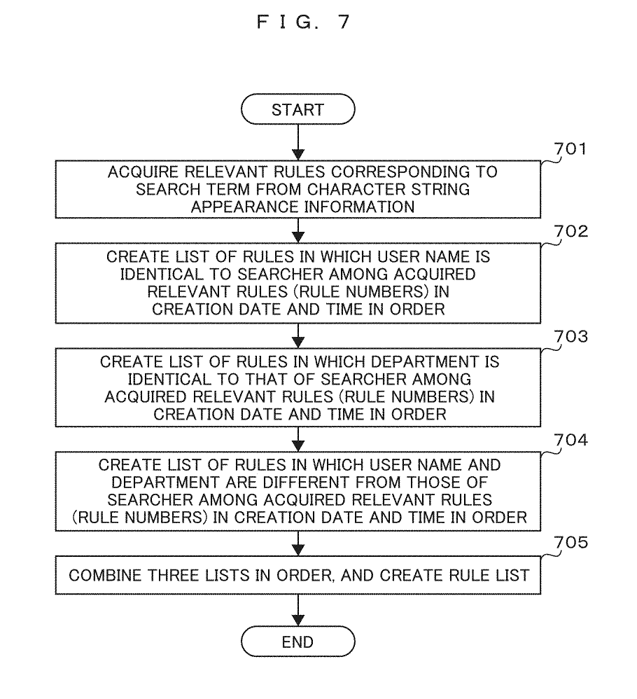

FIG. 7 is a diagram illustrating an example of a flowchart for creating a rule list. In step 701, the processor 201 compares the character string of the character string appearance information 207a with the search term “Mc-KEY,” specifies terms which are identical to each other, and acquires numbers of rules constituting relevant rules of the terms, that is, “0” and “2” of rule numbers. In step 702, the processor 201 determines whether or not there is “JIRO” which is the same as the user name of the searcher in the creator name in which the rule numbers of the rule information 206a are “0” and “2,” and creates a list in a creation date and time order when there is “JIRO” in a plurality of rules.

It is because when the same searcher inputs the same search term, the searcher often intends to obtain a similar search result, and thus the same term group of the same searcher is set to be likely to be used. Further, it is because that a possibility that a newly created term group is suitable for the purpose of search is high. In the example of FIG. 4, since the creator names in which the rule numbers are “0” and “2” are “SYSTEM” and “TARO,” the processor 201 does not create a list in step 702.

In step 703, the processor 201 determines whether or not there is “1A4G” which is identical to a department of the searcher in departments in which the rule numbers of the rule information 206a are “0” and “2,” and creates a list in a creation date and time order when there is “1A4G” in a plurality of rules. It is because the searchers belonging to the same department often search using the same product name, the same term group of the same department is set to be likely to be used. In the example of FIG. 4, since the department in which the rule number is “2” is identical to “1A4G,” a list is created according to a rule in which the rule number is “2.”

In step 704, the processor 201 determines whether or not the creator name and the department in which the rule numbers of the rule information 206a are “0” and “2” are different from the user name and the department of the searcher, that is, whether or not there is a rule in which a list is not created in steps 702 and 703, and creates a list in the creation date and time order when there are a plurality of rules. In the example of FIG. 4, since the creator name in which the rule number is “0” is “SYSTEM,” and there is no department, a list is created according to a rule in which the rule number “0.”

In step 705, the processor 201 combines the list created in step 702, the list created in step 703, and the list created in step 704 in this order, and creates one list. In this example, a rule in which the rule number is “2” and the rule in which the rule number is “0” become a rule list in this order. Here, the processor 201 may add a rule indicating only the search term input in step 603 to the rule list.

In the example of FIG. 7, in step 703, the processor 201 determines the department but may determine the user in the department in addition to the determination of the department. For example, the user who is large in the number of years among the users of the same department as the searcher is likely to have a skill close to an expert. Further, the user who is large in the number of searches or the user who is large in number of revisions of the search term among the users of the same department as the searcher is likely to have a skill close to an expert. In this regard, in step 703, when there are a plurality of users belonging to the same department as the searcher, the list may be created in the order of the number of years, the number of searches, or the number of revisions of the user attribute of the user information 300 instead of the creation date and time order. Further, when there are a plurality of users who are the same in the number of years, the number of searches, or the number of revisions of the user attribute, the list may be created in order of other numbers such as a creation date and time. For this process, the rule information 206 may include information of all the user attributes of the user information 300.

In step 605, the processor 201 displays the rule list created in step 604 on the menu 904 of the window 900a. For example, the menu 904 may be displayed by arranging the rules from the top to the bottom so that the rules are easily selected in the order of the list. In the example of FIG. 9, a rule in which the rule number is “2” is displayed on the top. When information of the term groups of a plurality of rules is displayed, since a display information amount is large, in the example of FIG. 9, the memo, the creator name, and the creation date and time of the rule information 206a are displayed.

Further, a rule indicating only the inputted search term is added in step 705, and “no expansion (system)” is displayed on the menu 904, When a plurality of rule list are created in step 604, a plurality of rules may be displayable together with a menu “more view” as indicated by window 900a. Further, when one rule in the menu 904 is selected by the mouse of the input device 203, and a button 902 is clicked, the processor 201 performs step 606.

The processor 201 acquires rule selection. In this example, “sales analysis of Mc-KEY (TARO Jul-8 16: 16)” is selected, and information indicating that “2” of rule number is selected is acquired. In step 607, the processor displays a window for revising the selected term, that is, the search term of the term group. This is the window 900b illustrated in FIG. 9. In the window 900b, “Mc-KEY” remains displayed in the input field 901 for confirmation of the input search term. Then, in step 608, the processor 201 acquires revision information of the search term in the selected rule.

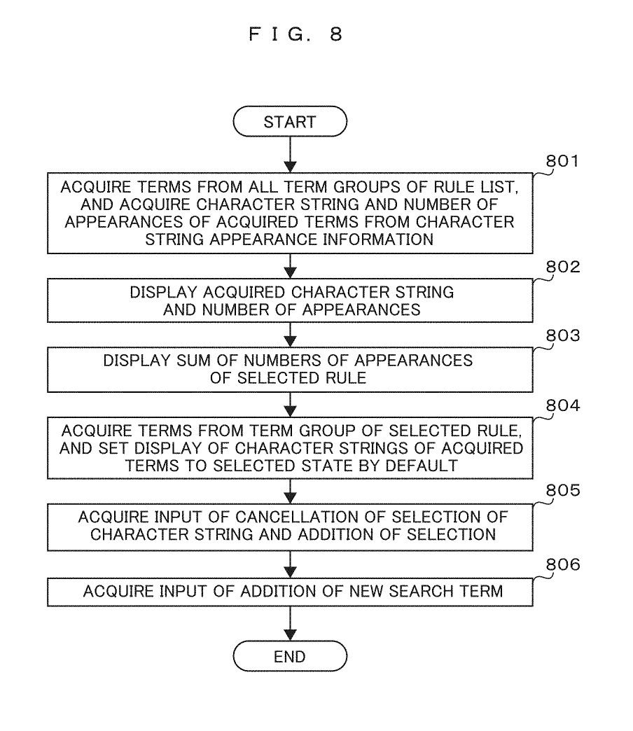

FIG. 8 is a view illustrating an example of a flowchart for revising the search term in the selected rule. The flowchart illustrated in FIG. 8 corresponds to steps 607 and 608 illustrated in FIG. 6. In step 801, the processor 201 acquires the search terms from all the term groups in the rule list created in step 705. They are the search terms included in the term group of the rules in which the rule numbers are “0” and “2” as described above, and the search terms constituting the term group of the rule in which the rule number is “0” is include the search terms constituting the term group of the rule in which the rule number is “2,” and thus they are the search terms included in term group 100 in FIG. 1. Then, the character strings and the number of appearances of the acquired search terms are acquired from the character string appearance information 207.

In step 802, the processor 201 causes the character string and the number of appearances acquired in step 801 to be displayed on display fields 907b and 907c. As illustrated in FIG. 9, the character strings and the number of appearances, that is, the character string “Mc-KEY” and the number of appearances “2, 302” are displayed in association with each other. In the example of the rule information 206a and the character string appearance information 207a of FIG. 1, there are eight kinds of search terms, that is, character strings, but when there are many types of search terms, some types of search terms may be displayed, and the remaining search terms may be displayed through scrolling of the window or the like. Further, it may be displayed in the upper portion of the window so that the user can easily see the rule selected in step S606, that is, the character string of the search term included in the term group of the rule in which the rule number is “2” in this example.

In step 803, the processor 201 calculates a sum of the number of appearances of the character strings included in the rule selected in step 606 based on the number of appearances acquired in step 801. In this example, 2,900,538 which is the sum of the number of appearances of the term numbers “4,” “7,” and “8” is calculated. Then, the calculated value is displayed in the display field 906. Here, information indicating that this value is a “result of the selected rule” may be displayed in the display field 906. Further, content of the rule may be acquired from the memo of the rule information 206a and displayed in the display field 906 as “sales analysis of Mc-KEY.” Further, “2,900,000” may be displayed using double digits as significant figures.

In step 804, the processor 201 acquires the term numbers from the term groups of all the rules included in the list created in step 705, and causes all the character strings of the acquired search terms in the display field 907b. In the example of FIG. 9, six character strings “Mc-KEY,” “McKEY,” “MCKEY,” “McKEY,” “mckey,” and “Mc-Key” are shown in the display field 907b, and when there are many character strings of the search terms, all of the character strings of the search terms may be displayed through scrolling of the window or the like.

Then, the processor 201 acquires the term numbers from the term group of the rule selected in step 606, and sets the display of the character strings of the acquired search term to a selected state by default. In the example of FIG. 9, squares (so-called check boxes) on the left of three character strings “Mc-KEY,” “McKEY,” and “MCKEY” among all six character strings in the display field 907b are black, and the character strings are displayed as the selected state. As a result, since the search term already included in the selected rule is selected, the user need not perform a new selection operation.

Instead of acquiring the term numbers from the term group of the rule selected in step 606, the term numbers may be acquired from the term group of the rule or the user determined in step 703, and the display of the character string of the acquired search term may be set to the selected state by default.

In step 805, the processor 201 acquires an input for cancelling the selection of the character string as the search term or adding selection. In the example of FIG. 9, when the clicks the black square on the left of “McKEY” set to the selected state in step 804 in the display field 907b using the mouse of the input device 203, it is changed to the white square on the left of “McKEY” in the display field 907c, and the selection of “McKEY” is canceled. Further, when the user clicks the white square on the left of “Mc_KEY” in the display field 907b, it is changed to the black square on the left of “Mc_KEY” in the display field 907c, and the selection of “Mc_KEY” is added.

In step 806, the processor 201 also acquires an input of a new search term to an input field 910c. In the example of FIG. 9, when the user clicks an input field 910b using the mouse of the input device 203, it is possible to input a character string through the keyboard of the input device 203, so that the character string “KEY-Mc” can be input as illustrated in the input field 910c. When the user clicks a button 911 using the mouse, the processor 201 acquires the character string input to the input field 910c. Thus, it is possible to search for a new character string that is not included in the previous rule.

Through steps 805 and 806, in the example of FIG. 1, the search term included in the term group 100 is displayed, and the search term included in the term group 101 is selected by default, whereas selection of “McKEY” is canceled, “Mc_KEY” is added, selection of a new search term “KEY-Mc” is also added, and the search term included in the term group 103 is a search target.

The processor 201 may perform a process to return to the window 900a when a button 905 is clicked in the windows 900b and 900c. For example, when the user who has seen the display field 906 or the display field 907b desires to change the selected because the number of appearances is larger than expected, the user can select the rule again by clicking the button 905 again. When a button 909 is clicked in the window 900c, the search term input or selected in the input field 910c or the display field 907c is saved as a new rule.

In other words, in step 609, the processor 201 stores information related to the new rule in the rule information 206 and the character string appearance information 207. In this example, a rule in which the rule number is “n” is added as indicated in the rule information 206b in addition to the rule information 206a. In the term group of this rule, “7” (“McKEY”) of the term group in which the rule number is “2” is released, “8” (“Mc_KEY”) and “m” (“KEY-Mc”) are added “4,” and “6,” “8,” and “m” are obtained. Further, a memo of a rule which is selected and serves as a basis may be copied to a memo in which the rule number of the rule information 206b is “n,” added as “sales analysis of Mc-KEY,” and revised later, and a memo input filed (not illustrated) may be provided in the window 900c so that a memo can be input.

Further, in this example, the rule number “n” is added to the relevant rules of the term numbers “4,” “6,” and “8” as indicated in the character string appearance information 207b in addition to the character string appearance information 207a. When the character string appearance information 207a has been created for all the character strings included in the text of the search target in advance, there is the term number “m” because the character number “KEY-Mc” has appeared as often as the number of appearances “p,” and thus the rule number “n” is added to the relevant rule of the term number “m”. When the character string appearance information 207a has not been created for all the character strings included in the text of the search target in advance, and the character string “KEY-Mc” is not included in the character string appearance information 207a, the term number may be set to “m,” and the character string “KEY-Mc” and the relevant rule “n” may be added. By revising the rule information 206b and the character string appearance information 207b, the rule in which the rule number “n” can be used for a next search.

When the user clicks a button 908 in the window 900c, the processor 201 performs a search in step 610. This search is performed using the character string position list of the character string appearance information 207b as described above. Here, when the character string “KEY-Mc” is not already included in the character string appearance information 207a, the number of appearances of the character number “m” of the character string appearance information 207b and the character string position list may be created by performing pattern matching on the text of the search target using the character string “KEY-Mc.”

In step 611, the processor 201 displays a result of the search in step 609 and ends the search process. Here, the process may return to step 601 without ending the process.

As described above, the search term used in the past in relation to the designated search term is displayed, and thus it is possible to easily reuse the search term used in the past. Particularly, since the display order of the search terms to be reused is controlled based on the attribute of the searcher, and the search terms to be reused enter the selected state by default, and thus it is possible to provide useful search terms so that the search terms can be easily used. Further, it is possible to revise the search term, and the revised search term can be used for the next search.

### REFERENCE SIGNS LIST

100, 101, 102, 103 term group
200 search system
206 rule information
207 character string appearance information

1. A character string search system, comprising:
a storage device that associates and stores an attribute of a searcher who inputs a search term for a first search and a term group including one or more search terms used for the first search as a rule;
a processor; and
a display device,
wherein the processor
specifies a first rule including the search term input by the searcher in a second search from among rules stored in the storage device, and
specifies a second rule including a searcher having an attribute close to the attribute of the searcher in the second search from the first rule.

2. The character string search system according to claim 1,
wherein the processor causes the second rule to be displayed on the display device so that the second rule is preferentially selectable.

3. The character string search system according to claim 2,
wherein the processor causes the second rule to be displayed on the display device so that the second rule is preferentially selectable by causing the first rule to be displayed on the display device and causing the second rule to be displayed at a position at which selection is likely to be performed during the display of the first rule.

4. The character string search system according to claim 2,
wherein the processor
receives selection of a rule in the display in which the second rule is preferentially selectable, and
performs display so that one or more search terms constituting a term group of the rule selected by the receiving is preferentially selectable.

5. The character string search system according to claim 4,
wherein the processor performs the display so that one or more search terms constituting the term group of the rule selected by the receiving is preferentially selectable by causing a search term of the first rule to be displayed on the display device and causing one or more search terms constituting the term group of the rule selected by the receiving to be displayed in a default selected state during the display of the search term of the first rule.

6. The character string search system according to claim 5,
wherein the processor receives cancelation of the default selected state or addition selection of a search term other than the default selected state during the display of the search term of the first rule.

7. The character string search system according to claim 1,
wherein the processor performs causes one or more search terms constituting a term group of the second rule to be displayed on the display device so that the one or more search terms constituting the term group of the second rule are preferentially selectable.

8. The character string search system according to claim 7,
wherein the processor performs causes the one or more search terms constituting the term group of the second rule to be displayed on the display device so that the one or more search terms constituting the term group of the second rule are preferentially selectable by causing the search term of the first rule to be displayed on the display device and causing the one or more search terms constituting the term group of the second rule in a default selected state during the display of the search term of the first rule.

9. The character string search system according to claim 8,
wherein the processor receives cancelation of the default selected state or addition selection of a search term other than the default selected state during the display of the search term of the first rule.

10. The character string search system according to claim 1,
wherein the storage device stores
rule information in which the attribute of the searcher who inputs the search term for the first search and the search term used for the first search are associated as a rule, and
character string information in which character strings of all available search terms are associated with a rule including a search term,
the processor
specifies a character string which is identical to a character string of the search term input by the searcher in the second search from the character string information,
specifies the first rule associated with the character string specified to be identical from the character string information, and
specifies the second rule including a searcher having an attribute close to the attribute of the searcher in the second search in the first rule from the rule information.

11. The character string search system according to claim 10,
wherein the processor
specifies a character string which is identical to a character string of the search term used for the second search from the character string information, and stores the specified character string in the rule information as a new rule together with the attribute of the searcher in the second search, and
stores the new rule in the character string information in association with the character string of the search term used for the second search.

12. The character string search system according to claim 1,
wherein the processor uses department information of the searcher as the attribute of the searcher.

13. A control method of a character string search system, comprising:
a step of associating and storing an attribute of a searcher who inputs a search term for a first search and a term group including one or more search terms used for the first search as a rule;
a step of specifying a first rule including the search term input by the searcher in a second search from among rules stored in a storage device, and
a step of specifying a second rule including a searcher having an attribute close to the attribute of the searcher in the second search from the first rule.

14. The control method of the character string search system according to claim 13, further comprising:
a step of causing the second rule to be displayed on the display device so that the second rule is preferentially selectable;
a step of receiving selection of a rule in the display in which the second rule is preferentially selectable, and
a step of performing display so that one or more search terms constituting a term group of the rule selected by the receiving is preferentially selectable.

15. The control method of the character string search system according to claim 13, further comprising,
a step of performs causes one or more search terms constituting a term group of the second rule to be displayed on the display device so that the one or more search terms constituting the term group of the second rule are preferentially selectable.
